(19) United States
(12) Patent Application Publication
(10) Pub. No.: US 2011/0094685 A1
(43) Pub. Date: Apr. 28, 2011

(54) ROMAN SHADE LINING PANEL ATTACHMENT

(76) Inventors: John E. Morris, Lake Mills, WI (US); Christopher J. Malin, Cross Plains, WI (US); Julie S. Kober, Sun Prairie, WI (US)

(21) Appl. No.: 12/847,755

(22) Filed: Jul. 30, 2010

Related U.S. Application Data
(60) Provisional application No. 61/230,388, filed on Jul. 31, 2009.

(51) Int. Cl. A47H 5/032; B23P 17/00

(52) U.S. Cl. 160/84.04; 29/433

(57) ABSTRACT

A Roman shade includes shade material and a lining panel connected to the shade material at a plurality of discrete connections located along horizontal rows of cord rings for lift cords of the shade.

### CROSS-REFERENCE TO RELATED APPLICATIONS

The present application claims the benefits of U.S. Provisional Application for Patent Ser. No. 61/230,388 filed Jul. 31, 2009.

### FIELD OF THE INVENTION

The present invention relates generally to window coverings and, more particularly, to so-called “Roman shades”, and still more particularly to Roman shades having lining panels.

### BACKGROUND OF THE INVENTION

Roman shades have long been used for both decorative and functional coverings on windows and other architectural openings. Roman shades made of many different materials have been used, including lightweight fabrics, heavier fabrics, horizontally slatted material of wood or faux-wood, woven fibrous materials and other natural and synthetic materials. When fabric materials are used, either a single ply heavy fabric or a lighter weight fabric with or without linings can be used to provide a high degree of privacy and light blocking. When the slatted or woven materials are used, gaps between the slats or woven materials can permit entrance of undesirable light streams, which may provide an undesirable appearance. Accordingly, it has been known to provide a fabric lining panel on the window side of wood, faux wood and other Roman shades having shade panels that are open or widely porous.

In a known construction, the lining panel is attached to the headrail and along the edges with a pattern of hand stitches. The shade requires vertical columns of cord rings attached to the back of the shade to guide the cords that are used to lift the shade. In a known construction, the rings are attached to the wood or faux wood panel and extended through slits in the lining panel. Alternatively, the cord rings are attached directly through the lining panel fabric. In either construction, the cord rings hold the lining panel in place but are exposed on the back of the shade, and the lift cords are extended along the outer surface of the lining material on the back of the shade. Disadvantages from this construction include having cords and rings that are visible on the back of the shade, particularly if the cords are not of the same color as the lining panel. Visible cords are undesirable. Exposed cords can present operational difficulties and safety concerns. Any slits or breach in the lining panel fabric can allow light leakage, and the slits can tend to fray from movement of the cords when the blind is operated. Further, when slitting the lining panel to accommodate the cord rings, or when attaching cord rings through the lining panel, it is difficult to get the slits and/or rings aligned properly, and it is easy to create puckers in the lining panel fabric that present an aesthetically undesirable appearance. Generally, the time required to assemble a blind of this type is longer than desirable, adding to manufacturing costs.

Attaching the lining over the cords, with the cord sandwiched between the lining and the primary shade material can provide a clean look on the street side of the shade. It is known to provide the lining with pleats to define spaced tabs on the inside of the lining panel fabric. The lift corridor then passes through the cord rings on the shade and through holes in the tabs on the inside of the lining. Alternatively, the lining panel can be provided as a functionally separate shade, requiring a dedicated lift system that operates independently of the main shade. Each of these constructions for concealing the lift cords is complex, adding to the difficulty and expense of manufacture and assembly.

A simpler construction, that can be assembled more easily, is desirable and advantageous.

### SUMMARY OF THE INVENTION

A lined Roman shade construction that is easy to assemble, aesthetically pleasing and a functional improvement over known constructions for Roman shades with linings, while also overcoming disadvantages of exposed lift cords is provided.

In a form thereof, a Roman shade is provided with a headrail, shade material depending from the headrail and a lining panel substantially coextensive with the shade material. Cord rings are connected to the shade material and positioned between the shade material and the lining panel. The cord rings are arranged in vertical columns and horizontal rows. Lift cords depend from the headrail and extending through the cord rings in vertical columns. Discrete attachment points of the lining panel to the shade material substantially are aligned horizontally with horizontal rows of the cord rings.

In another a form thereof, a method for assembling a Roman shade is provided with steps of securing cord rings to shade material in vertical columns and horizontal rows; threading lift cords through individual cord rings in the vertical columns of cord rings; placing a lining panel over the cord rings and lift cords and against the shade material; and attaching the lining panel to the shade material at discrete connections aligned with horizontal rows of cord rings.

In a further aspect of a form thereof, a Roman shade is provided with shade material, a lining panel and cord rings connected to the lining panel. The cord rings are arranged in a plurality of horizontal rows. Discrete connections of the lining panel to the shade material are aligned with the horizontal rows of the cord rings.

Attachment of the lining panel to the shade material in at least some forms thereof provides an aesthetically appealing, smoothly and consistently operating shade with concealed and protected lift cords and cord rings.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of a Roman shade with a lining attached thereto in accordance with the design and procedure described herein;

FIG. 2 is a perspective view of the Roman shade in a different orientation to better reveal the construction and method of assembly;

FIG. 3 is a perspective view of the Roman shade during assembly

FIG. 4 is a further perspective view of the Roman shade during assembly, with the lining thereof elevated to reveal inner components of the shade;

FIG. 5 is a cross-sectional view through the Roman shade;

FIG. 6 is a cross-sectional view showing an alternate construction; and

FIG. 7 is a cross-sectional view of another alternate construction.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

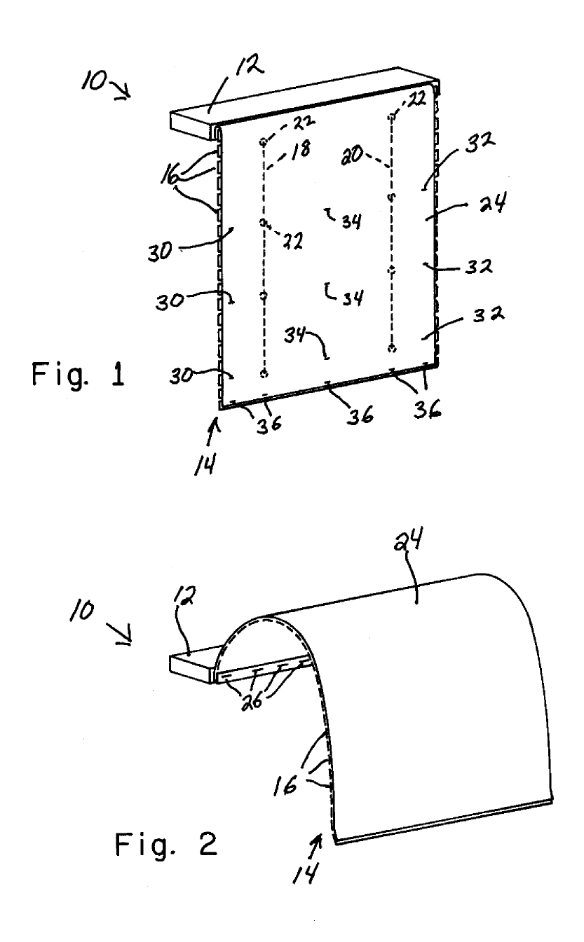

Referring now more particularly to the drawings, FIG. 1 illustrates a Roman shade 10 of the construction to be described herein. Roman shade 10 includes a headrail 12 shade material 14, which in the exemplary embodiment includes a plurality of horizontal slats 16, some of which but not all of which are identified with reference numerals in the drawings. Roman shade 10 further includes lift cords 18, 20 extending from the headrail in substantially parallel vertical paths to the lower end of shade material 14. It should be understood that slats 16 can be made of wood, faux wood or other natural or synthetic materials. While relatively simplistic individual slats 16 are shown, it should be understood that Roman shades of this type can be provided of woven materials of a more complex overall appearance. Rather than slats 16, shade material 14 also can be a panel of fabric. The present construction for a Roman shade can be used with any type of shade material when a lining therefor is desired. The simple design of shade material 14 is shown for simplicity of illustration.

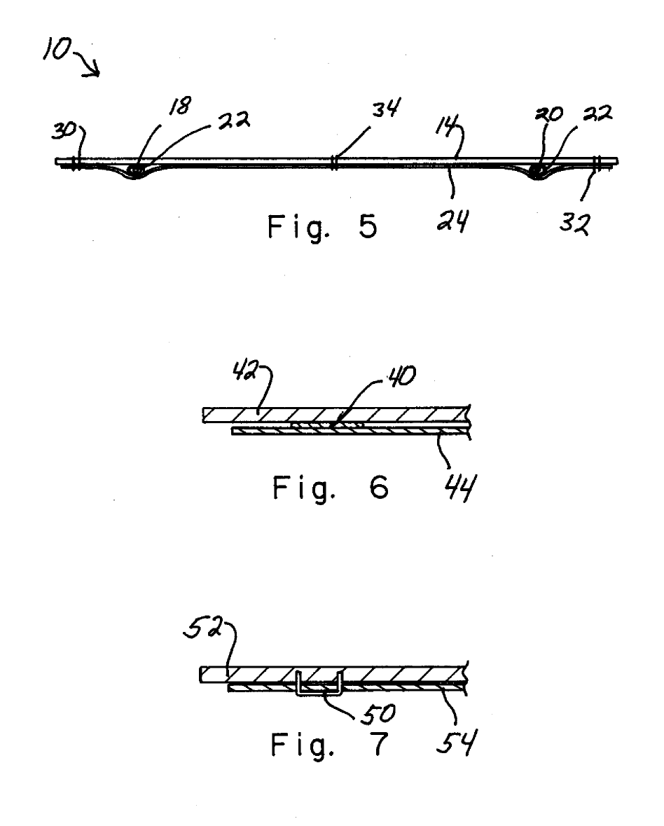

Lift cords 18, 20 pass through columns of vertically spaced cord rings 22 so that cords 18, 20 can slide through the rings 22 as shade material 14 is bunched when lifting Roman shade 10, or loosened and extended when lowering Roman shade 10. Lift cords 18, 20 and cord rings 22 are disposed between shade material 14 and a lining panel 24. Accordingly, to facilitate a better understanding of the construction of Roman shade 10, in FIGS. 1 and 4 the locations of concealed portions of lift cords 18, 20 and/or concealed cord rings 22 hidden behind lining panel 24 are illustrated by dashed lines. As those skilled in the art will readily understand, individual cord rings 22 are also aligned in a plurality of horizontal rows between the top and bottom of shade material 14 so that when lift cords 18, 20 are raised, shade material 14 bunches in uniform horizontal folds along the horizontally aligned rows of cord rings 22. Cord rings 22 can be attached to shade material 14 by any means suitable, such as, for example and not limitation, by sewing, the use of fasteners, suspended from hangers of various types embedded or otherwise retained in the structure and material of shade material 14, etc.

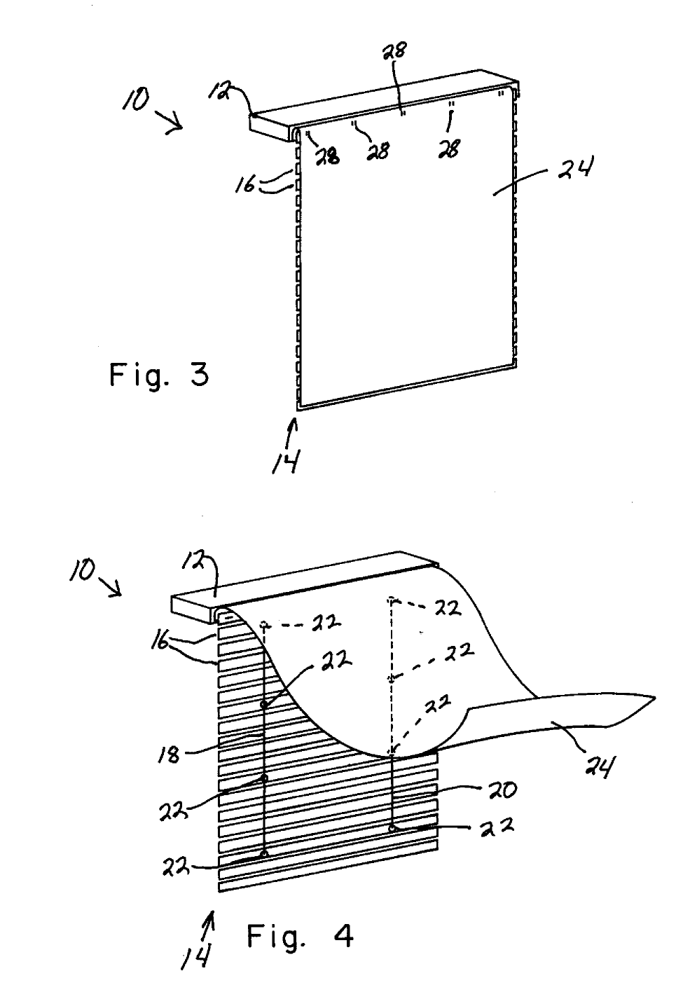

For functional and/or aesthetic purposes, including to providing increased privacy and light blocking, lining panel 24 is provided as a liner or backing to shade material 14. It is desirable and aesthetically preferable that lining panel 24 bunches substantially consistently with the bunching of shade material 14 when lift cords 18, 20 are raised, and that lining panel 24 remains substantially aligned with shade material 14 when lift cords 18, 20 are extended to lower shade material 14. Lining panel 24 is attached to headrail 12 and against shade material 14 with concealed fasteners such as staples or nails 26 (FIG. 2) which are overlapped by the installed shade, or with glue or other means. Lining panel 24 also can be attached to shade material 14 by stitches 28 (FIG. 3) across the top of shade 10 at or below headrail 12.

Lining panel 24 is draped down the back of Roman shade 10, covering lift cords 18, 20 and cord rings 22 to both conceal and protect lift cords 18, 20 and cord rings 22. Lining panel 24 is fastened or attached to shade material 14 at discrete, spaced locations along the extent thereof. In the exemplary embodiment, lining panel 24 is stitched to shade material 14 in vertical columns of stitches 30, 32 (FIG. 1) near the side edges of Roman shade 10, between the vertical columns of cord rings 22 and the outer side edges of the shade. Each stitch of the vertical columns of stitches 30, 32 also is substantially aligned horizontally with one of the horizontal rows of cord rings 22. Accordingly, in the exemplary embodiment shown, two horizontally aligned cord rings 22, one stitch 30 outwardly of the two cord rings 22 on one side, and one stitch 32 outwardly of the two cord rings 22 on the other side are substantially aligned horizontally. Stitches 30, 32 can be provided in some or in all of the horizontal rows of cord rings 22

For wide shades, additional vertical columns of discrete attachments such as stitches 34 can be provided between the vertical columns of cord rings 22, with the individual stitches 34 being aligned horizontally with the cord rings 22 of a horizontal row and the individual stitches 30, 32 in outboard columns of stitches 30, 32. The pattern of horizontally aligned stitches 30, 32, 34 aligned with pairs of cord rings 22 controls how the lining panel piles or bunches as the shade is raised. Stitches 34 can be provided in some or in all of the horizontal rows of cord rings 22.

A horizontal row of stitches 36 also can be provided to attach the bottom edge of lining panel 24 to the bottom edge of shade of material 14.

Stitches 30, 32, 34 secure lining panel 24 to shade material 14. Since individual stitches 30, 32, 34 also are aligned horizontally with horizontal rows of cord rings 22, lining panel 24 folds and bunches in the same pattern as and in close relationship to shade material 14, as shade material 14 bunches when lift cords 18, 20 are raised.

The stitches 30, 32, 34 described herein can be applied by hand or by automated machinery. Alternatively, other fastening techniques can be used to create discrete, spaced connections between shade material 14 and lining panel 24, with the discrete, spaced connections aligned as for the stitches 30, 32, 34 described above. For example, garment tag fasteners, staples, glue, heat-fusible tape or other attachment methods can be used to establish the connections between shade material 14 and lining panel 24.

FIG. 6 illustrates an intermediate attachment body 40 between shade material 42 and a lining panel 44. Attachment body 40 can be glue, heat-fusible tape or other adhesive or bonding structures.

FIG. 7 illustrates the use of a staple 50 in place of the individual stitches 30, 32, 34; with staple 50 being anchored in shade material 52 and extending through lining panel 54.

While shown and described herein for a Roman shade having slats of wood or other natural or synthetic materials, the construction and method described herein can be used for fabric Roman shades having fabric shade panels and fabric lining panels

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A Roman shade, comprising:
a headrail,
shade material depending from the headrail;
a lining panel substantially coextensive with the shade material;
cord rings connected to said shade material and positioned between said shade material and said lining panel, said cord rings arranged in vertical columns and horizontal rows;
lift cords depending from the headrail and extending through said cord rings in vertical columns; and
discrete attachment points of said lining panel to said shade material substantially aligned horizontally with horizontal rows of said cord rings.

2. The Roman shade of claim 1, said discrete attachment points arranged in two vertical columns along side edges of said shade.

3. The Roman shade of claim 2, including further discrete attachment points of said lining panel to said shade material, said further discrete attachment points being located between vertical columns of said cord rings.

4. The Roman shade of claim 1, said discrete attachment points being stitches.

5. The Roman shade of claim 1, said discrete attachment points being staples.

6. The Roman shade of claim 1, said discrete attachment points being adhesive bonds.

7. The Roman shade of claim 1, including a horizontal row of stitches connecting said lining panel to said shade material along lower edges of said lining panel and said shade material.

8. The Roman shade of claim 1, including discrete attachment points aligned with each of said horizontal rows of cord rings.

9. The Roman shade of claim 8, said discrete attachment points arranged in two vertical columns along side edges of said shade.

10. The Roman shade of claim 9, including further discrete attachment points of said lining panel to said shade material, said further discrete attachment points being located between vertical columns of said cord rings.

11. A method for assembling a Roman shade comprising steps of:
securing cord rings to shade material in vertical columns and horizontal rows;
threading lift cords through individual cord rings in the vertical columns of cord rings;
placing a lining panel over the cord rings and lift cords and against the shade material; and
attaching the lining panel to the shade material at discrete connections aligned with horizontal rows of cord rings.

12. The method of claim 11, said attaching performed to create vertical columns of discrete connections between vertical columns of cord rings and side edges of the shade.

13. The method of claim 12, including a further step of attaching the lining panel to the shade material in a vertical column of discrete connections located between two vertical columns of cord rings.

14. The method of claim 11, said attaching performed by stitching.

15. The method of claim 11, said attaching performed by stapling.

16. The method of claim 11, said attaching performed by bonding.

17. The method of claim 11, said attaching performed by stitching the lining panel to the shade material at discrete connections located between a vertical column of cord rings and side edges of the shade.

18. The method of claim 17, including a further step of stitching the lining panel to the shade material at discrete connections located between two vertical columns of cord rings.

19. The method of claim 11, including stitching the lining panel to the shade material along lower edges of the lining panel and the shade material.

20. A Roman shade, comprising:
shade material;
a lining panel;
cord rings connected to the lining panel, said cord rings arranged in a plurality of horizontal rows; and
discrete connections of said lining panel to said shade material aligned with said horizontal rows of said cord rings.

21. The Roman shade of claim 20, said discrete connections being stitches.

22. The Roman shade of claim 20, said discrete connections located between outermost cord rings and side edges of said shade.

23. The Roman shade of claim 22, including further discrete connections of said lining panel to said shade material, said further discrete connections being located between adjacent cord rings within a horizontal row of cord rings.
